(19) United States
(12) Patent Application Publication
(10) Pub. No.: US 2012/0234596 A1
(43) Pub. Date: Sep. 20, 2012

(54) ELASTIC HIGH VOLTAGE ELECTRIC PHASES FOR HYPER DEPTH POWER UMBILICAL'S

(76) Inventor: Sjur Kristian Lund, Halden (NO)

(21) Appl. No.: 13/405,768

(22) Filed: Feb. 27, 2012

(30) Foreign Application Priority Data
Mar. 14, 2011 (NO) 2011 110393

(51) Int. Cl. H01B 7/18; H01B 13/00

(52) U.S. Cl. 174/70 R; 29/825

(57) ABSTRACT

A power umbilical cable includes one or more axial elongate phases for conducting electrical current, and one or more axial elongate structural components adapted to undergo stress to withstand axial and bending strain applied to the power umbilical cable in operation. The umbilical cable has an outer protection layer, each of the phases having a conductive core made of a plurality of metal wires. Each current conducting core includes at a central portion therein, and surrounded by the plurality of conductive metal wires, a flexible element to enable the wires to move in a radial direction to reduce their strain when the umbilical cable is subject in operation to stress causing the one or more elongate structural components to be axially strained.

### RELATED APPLICATION

This application claims the benefit of priority to Norwegian Patent Application No. 2011 110393, filed on Mar. 14, 2011, the entirety of which is incorporated by reference.

### BACKGROUND

1. Field of the Invention

The present invention relates to power umbilical cables, for example to hyper depth power umbilical cables including elastic high voltage electrical phases. Moreover, the present invention relates to elastic high voltage electrical phases suitable for use in constructing such umbilical cables.

2. Description of the Related Art

Contemporary power umbilical cables, for example used in offshore environments such as laid onto a seabed, are subject to considerable mechanical stress when being installed and also subsequently when in operation. It is conventional practice to employ insulated multi-stranded copper conductors enclosed within a sealing polymer outer sheath for carrying electric current through these power umbilical cables. The copper conductors are conventionally referred to as being “phases”. For achieving an appropriate degree of robustness in the aforesaid umbilical cables, it is conventional practice to include strengthening steel tubes in parallel, and insulated from, the copper phases. When subjected to axial stress, the power umbilical cables undergo strain in response to such stress, wherein the strain is observed as an axial elongation of the umbilical cables. The strengthening steel tubes stretch in response to an application of the axial stress; the axial stress can result from radial bending of the umbilical cable or axial stretching loads being applied to the umbilical cables.

A problem arising in practice is that the strengthening steel tubes are capable of withstanding a strain of approximately 0.3% in response to stress being applied, whereas the copper phases are only capable of withstanding approximately 0.1% strain. It is conventional practice to utilize Super Duplex Steel is an advanced steel which exhibits a tensile strength in a range of 600 to 930 MPa depending upon tube manufacturer, a proof strength of substantially 0.2%, a elongation performance of 25% and a Brinell hardness of substantially 290 HB. Such mechanical characteristics provide Super Duplex Steel with an elongation capacity approximately in a range of 0.3% to 0.45%. Excessive elongation of the copper phases causes the phases to break. In consequence, it is conventional practice to implement the strengthening steel tubes to be stiffer than strictly necessary for their own integrity when subjected to stress in order to protect the copper phases. In consequence, the umbilical cable is correspondingly heavier and more costly than necessary in respect of the steel strengthening tubes. In practice, this means that only about 30% of the strength of the strengthening steel tubes is utilized in practice.

In power umbilical cables, Super Duplex steel tubes and copper power phases are located in a same lay-layer. Consequently, it is it is difficult to obtain elongation due to radial deformation caused by axial force, because the strengthening tubes and the power phases will undergo a mutually similar elongation when subjected, for example, to axial stress. When it is desirous to increase a power-carrying capacity of a given umbilical cable without making it bigger, heavier and more costly, is to increase the elongation capacity of the copper phases, in order to use a full range of stress which the strengthening tubes are capable of withstanding. Conventional known designs of umbilical cables have a maximum practical length of around 2000 m in offshore environments. Such a length is impractically short for future offshore installations. By increasing elongation capacities of conventional of umbilical cables, it is feasible to achieve power supply via such umbilical cables to greater depths of water.

### SUMMARY OF THE INVENTION

The present invention seeks to provide a power umbilical cable which is lighter and uses less material in its manufacture for a given power carrying capacity.

Moreover, the present invention seeks to enhance a power carrying capacity of power umbilical cables for a given weight and quantity of material employed in producing the umbilical cable.

Furthermore, the present invention seeks to provide an umbilical cable which can be employed to greater depths in offshore environments in comparison to conventional power umbilical cables.

According to a first aspect of the present invention, there is provided a power umbilical cable including one or more axial elongate phases for conducting electrical current, and one or more axial elongate structural components adapted to undergo stress to withstand axial and bending strain applied to the power umbilical cable in operation, the umbilical cable comprising an outer protection layer, each of said phases comprising a conductive core made of a plurality of metal wires characterized in that

each current conducting core includes at a central portion therein and surrounded by the plurality of conductive metal wires, a flexible element to enable the wires to move in a radial direction to reduce their strain when the umbilical cable is subject in operation to stress causing the one or more elongate structural components to be axially strained.

The invention is of advantage in that inclusion of the flexible elements within the cores enables the cable to operate to a strain limit determined by the elongate structure components.

Optionally, the power umbilical cable is manufactured such that the one or more elongate structural components are fabricated from super duplex steel tubes with a polymeric material sheath surrounding each tube.

Optionally, the power umbilical cable is manufactured such that the one or more phases include the wires fabricated from Copper, wherein the one or more phases include polymeric material insulation therearound.

Optionally, the power umbilical cable is manufactured such that the one or more elongate structural components are fabricated from a material having a greater critical strain limit in comparison to a current conducting material used to fabricate the plurality of wires for the one or more elongate phases, and the one or more elements of the one or more phases are operable to enable the plurality of wires to cope with a strain corresponding to the critical strain limit of the one or more elongate structure components.

Optionally, the power umbilical cable is manufactured such that the one or more elongate structural components are included within the umbilical cable spatially interspersed between the one or more elongate phases. More optionally, interstitial spaces between the one or more structural components and the one or more elongate phases are at least partially filled by flexible polymeric material spacers.

Optionally, the power umbilical cable is manufactured such that the cable includes an elongate structural component at a central region thereof.

Optionally, the power umbilical cable is manufactured such that the outer protection layer includes at least one layer of armour and at least one layer of polymeric material therearound.

Optionally, the power umbilical cable is manufactured such that the one or more phases are fabricated so that their wires have progressively smaller diameter radially outwardly from their corresponding one or more elements.

According to a second aspect of the present invention, there is provided a phase including a core including a plurality of elongate conductive wires, the core being surrounded by a circumferential insulating sheath, characterized in that the core includes a central elongate element therein surrounded by the plurality of wires, the central elongate element being operable to flex to reduce a strain experienced in operation by the plurality of elongate conductive wires.

Optionally, the phase is manufactured such that the plurality of elongate conductive wires are fabricated from Copper, and the central elongate element is fabricated from a flexible polymeric material.

According to a third aspect of the invention, there is provided a method of enhancing strain properties of a power umbilical cable, characterized in that the method includes:

(a) arranging for a power umbilical cable to including one or more axial elongate phases for conducting electrical current, and one or more axial elongate structural components adapted to undergo stress to withstand axial and bending strain applied to the power umbilical cable in operation, the umbilical cable being protected within an outer protection layer; and
(b) including in the one or more elongate phases corresponding one or more current conducting cores, wherein each core comprises a plurality of mutually abutting conductive metal wires, and wherein each current conducting core includes at a central portion therein surrounded by the plurality of conductive metal wires, the central portion including a flexible element operable to enable the wires to move in a radial direction to reduce their strain when the umbilical cable is subject in operation to stress causing the one or more elongate structural components to be axially strained.

### BRIEF DESCRIPTION OF THE DRAWINGS

Embodiments of the present invention will now be described, by way of example only, with reference to the following diagrams wherein:

FIG. 1 is an illustration of a conventional copper phase of a power umbilical cable;

FIG. 2 is an illustration of a copper phase pursuant to the present invention, the copper phase being usable in a power umbilical cable of FIG. 3;

FIG. 3 is an illustration of a copper phase of a power umbilical cable pursuant to the present invention of a power umbilical cable pursuant to the present invention;

FIG. 4A and FIG. 4B are illustrations of the copper phase of FIG. 1 and FIG. 2 subject to low and high axial stress respectively; and

FIG. 5 is an illustration of an example application of the power umbilical cable of FIG. 3.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS OF THE INVENTION

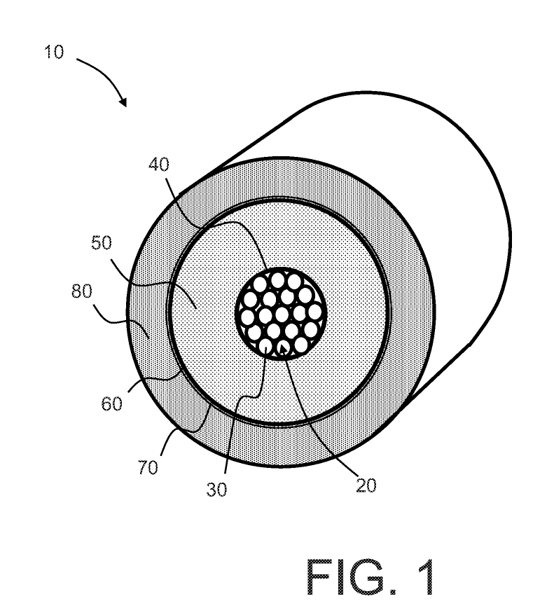

In FIG. 1, a conventional copper phase of a power umbilical cable is indicated generally by 10. The copper phase 10 includes a core 20 comprising a plurality of annealed Copper wires 30; optionally, wires fabricated from other materials are employed, for example Aluminium. A semi-conducting sheath 40 circumferentially surrounds the core 20. Moreover, a cross-linked polyethylene polymer insulation layer 50 circumferentially surrounds the sheath 40. Furthermore, a semi-conducting sheath 60 circumferentially surrounds the polymer insulation layer 50. Additionally, a copper wrapping 70 and finally a cross-linked polyethylene polymer insulation layer 80 circumferentially surrounds the semi-conducting sheath 60. The semi-conductor layers 40, 60 serve to reduce a risk of localized electric field concentrations at an inner and outer periphery of the layer 50 which could risk electrical discharge from the core 20 to the copper wrapping 70.

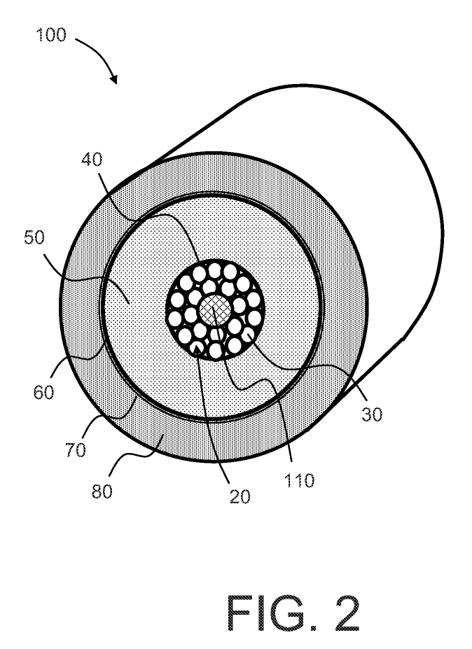

The present invention is concerned with copper phase indicated generally by 100 in FIG. 2, wherein an inventive feature involves including a polymer or elastomer bolt 110, namely a central flexible element, in a central axial portion of the core 20. Optionally, the bolt 110 is preferably cross-bonded and is fabricated from a polymer or elastomer material, for example from a polyethylene polymer material. The bolt 110 is functional as a soft bedding for the copper wires 30. Optionally, two layers of copper wires 30 are employed, wherein the copper wires 30 are laid at an angle within a range of 10° to 25°, and more optionally in a range of 17° to 20°. Optionally, in FIG. 2, interstices between the wires 30 are filled with one or more saturants, namely strand sealers and water blockers, for example Solarite KM series materials (see http://www.solarcompounds.com/products/wacc.asp#2 for more details). Employing such a large lay angle in FIG. 2 for the wires 30 renders the phase 100 flexible such that axial stress causing elongation of the phase 110 causes the wires 30 to squeeze harder onto the bolt 110, thereby providing the phase 110 with an enhanced strain characteristic relative to the phase 10 illustrated in FIG. 1.

Optionally, the phase 100 is manufactured so that the bolt 110 has an outer diameter in a range of 4 mm to 8 mm, more optionally substantially 6 mm. The core 20 in the phase 100 optionally includes in a range of 30 to 45 copper wires, more optionally substantially 38 copper wires: the core 20 optionally has an outer diameter in a range 10 mm to 14 mm, more optionally substantially 12 mm. The semi-conducting sheath 40 optionally has a radial thickness in a range of 0.5 mm to 1.5 mm, more optionally a thickness of substantially 1 mm. The polymer insulation layer 50 optionally has a radial thickness in a range of 4 mm to 7 mm, more optionally substantially 6 mm. The semi-conducting sheath 60 optionally has a radial thickness in a range of 0.5 mm to 1.5 mm, more optionally a thickness of substantially 1 mm. The copper wrapping 60 has a radial thickness in a range of 0.05 mm to 0.2 mm, more optionally substantially a thickness of substantially 0.1 mm. Optionally, the copper wires 30 are arranged to be of substantially mutually similar diameter. Alternatively, the wires 30 are arranged to have progressively smaller diameter in a radial direction outwardly from the bolt 110.

The aforementioned lay angle of the wires 30 on the phase 100 enables the wires to squeeze harder onto the bolt 110 when the phase 100 is exposed to axial loads, thereby resulting in axial elongation of the wires 30 such that tension in the wires 30 is kept below a critical limit at which the wires 30 could sustain stress damage.

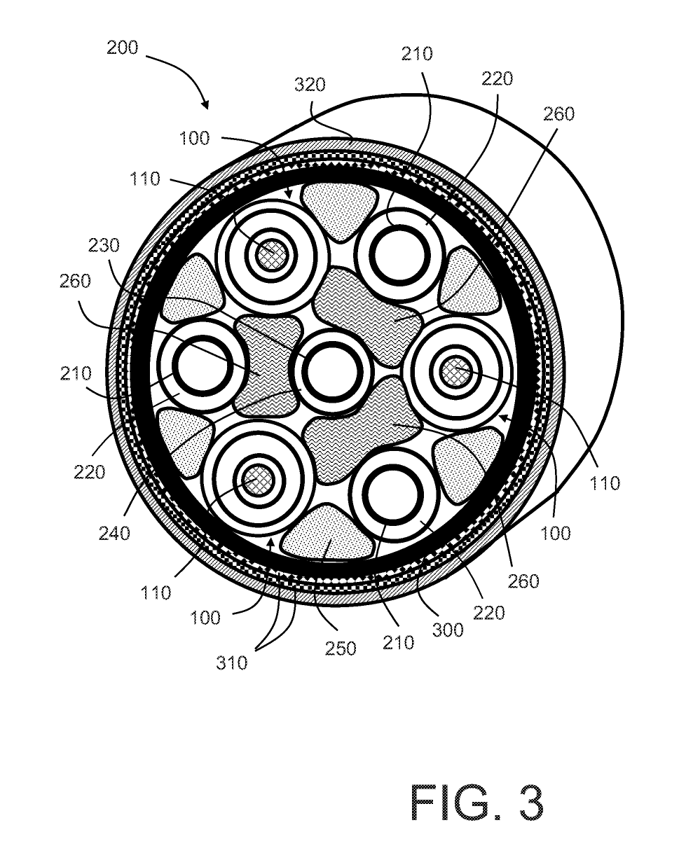

Referring next to FIG. 3, there is a shown a power umbilical cable indicated generally by 200. The power umbilical cable 200 is suitable for use in submerged ocean environments, in mines, in boreholes and such like. The umbilical cable 200 includes three of the aforementioned phases 100 with three Super Duplex steel tubes 210 spatially disposed between the phases 100. The steel tubes 210 are themselves each enclosed within a corresponding polyethylene sheath 220. A central portion of the cable 200 includes a central Super Duplex steel tube 230 which is also protected within a polyethylene sheath 240. Peripheral interstitial spaces 250 are filled with six bunches of polypropylene yarn or polyethylene profiles, and interstitial spaces 260 surrounding the central tube 230 are filled with polyethylene profiles as illustrated. Collectively surrounding the phases 100 and the steel tubes 210 is a polyethylene sheath 300, and therearound two concentric layers of armour wire layer 310, for example of a flat grade 95 wire, wherein each layer 310 has a radial thickness in a range of 4 mm to 8 mm, more optionally a radial thickness of substantially 6 mm. At an extreme circumferential peripheral of the cable is included a polyethylene sheath 320.

Operating characteristics of the cable 200 are determined by elongation capacities of the steel tubes 210, 230, by the armour layer 310 and the copper phases 100 in FIG. 3. The characteristics in respect of axial and lateral bending stresses are limited by a component of the cable 200 which has a lowest elongation capacity. An optimal implementation of the cable 200 ensures that a maximum elongation capacity of the steel tube 210, 230 and the armour layer 310 is utilized, subject to the phases 100 experiencing an elongation stress which is below a critical stress limit which the copper wires 30 of the phases 100 are capable of withstanding, namely substantially 0.1% stress.

The cable 200 thus has an elongation stress capacity of approximately 0.3% which enables it to be employed as considerable greater water depths offshore. Moreover, the cable 200 provides such benefits without needing to be increased in diameter in comparison to corresponding power capacity conventional umbilical cables. Implementing the cable 200 thus does not require an increased use of copper material and hence is commercially economical in comparison to conventional umbilical cables of similar power carrying capacity. Optionally, the cable 200 pursuant to the present invention is also susceptible to being employed in shallow water applications, for example for coupling to near-shore wind farm facilities.

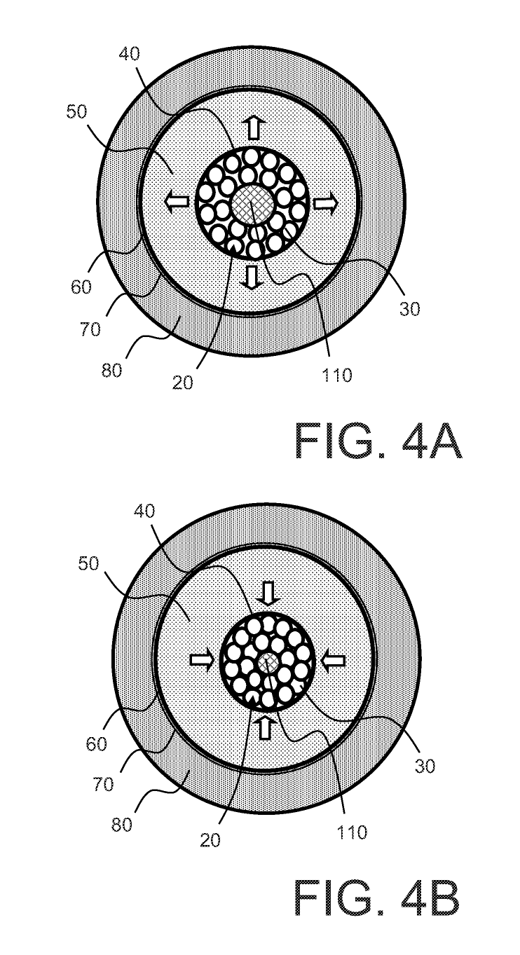

Referring to FIG. 4A and FIG. 4B, there is illustrated the copper phase 100 being subject to a relatively low axial stress in FIG. 4A, and to a relatively high axial stress in FIG. 4B. It will be seen from FIG. 4A and FIG. 4B that the wires 30 move in a radial manner in response to axial stress, wherein the radial movement is rendered possible by the bolt 110 being flexible and altering in its outside diameter in response to stress being applied thereto.

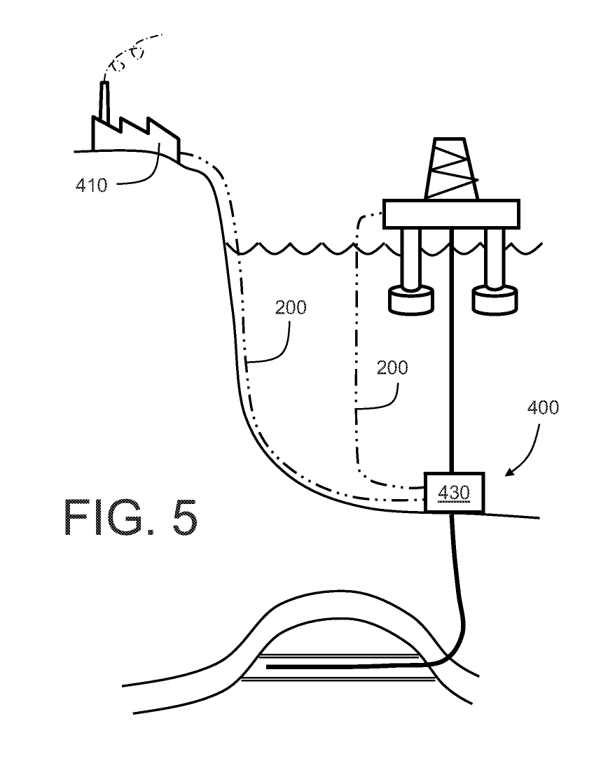

Referring to FIG. 5, the umbilical cable 200 is employed in a seabed oil and gas exploration and production facility 400 to provide power from a surface location 410 on land 420 to a seabed based facility 430, for example operating beneath an ice sheet near the North Pole. In operation, the seabed based facility 430 is progressively assembled using submersible remotely operated vehicles (ROV), and then the cable 200 is flexibly coupled to the facility 430 via suitable underwater connectors used to terminate the cable 200. The cable 200 is also susceptible to being used in one or more of following applications:

(a) down borehole probes, for example as described in published international patent applications nos. WO/2010/151136 (“Transducer Assembly”, TecWel AS), WO/2009/099332 (“Data Communication Link”, TecWel AS);
(b) offshore wind turbine farms, offshore wave energy farms, for example as described in a published international PCT application no. WO/2005/021961 (“A wind turbine for offshore use”, Norsk Hydro ASA);
(c) power and signal connections for offshore oil and gas platforms, for example as described in a published international POT application no. WO/2004/110855 (“Semi-submersible multicolumn floating offshore platform”, Deepwater Technologies Inc.); and
(d) power and signal connections for seabed oil and gas production facilities;
(e) ocean bed power and communication cables, for example for linking island electrical power networks to mainland electrical power networks.

Although use of polymeric materials such as polyethylene and cross-linked polyethylene are suitable for use in manufacturing the phase 100 and the cable 200, it will appreciated that other polymeric materials are optionally employed in manufacture, for example polypropylene, polyurethane, polytetrafluoroethylene (PTFE).

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A power umbilical cable including one or more axial elongate phases for conducting electrical current, and one or more axial elongate structural components adapted to undergo stress to withstand axial and bending strain applied to the power umbilical cable in operation, said umbilical cable comprising an outer protection layer, each of said phases comprising a conductive core made of a plurality of metal wires wherein,
each current conducting core includes at a central portion therein, and surrounded by said plurality of conductive metal wires, a flexible element to enable said wires to move in a radial direction to reduce their strain when said umbilical cable is subject in operation to stress causing said one or more elongate structural components to be axially strained.

2. The power umbilical cable as claimed in claim 1, wherein said one or more elongate structural components are fabricated from super duplex steel tubes with a polymeric material sheath surrounding each tube.

3. The power umbilical cable as claimed in claim 1, wherein said one or more phases include said wires fabricated from Copper, wherein the one or more phases include polymeric material insulation therearound.

4. The power umbilical cable as claimed in claim 1, wherein said one or more elongate structural components are fabricated from a material having a greater critical strain limit in comparison to a current conducting material used to fabricate said plurality of wires for said one or more elongate phases, and said one or more elements of said one or more phases are operable to enable said plurality of wires to cope with a strain corresponding to the critical strain limit of the one or more elongate structure components.

5. The power umbilical cable as claimed in claim 1, wherein said one or more elongate structural components are included within said umbilical cable spatially interspersed between said one or more elongate phases.

6. The power umbilical cable as claimed in claim 5, wherein interstitial spaces between said one or more structural components and said one or more elongate phases are at least partially filled by flexible polymeric material spacers.

7. The power umbilical cable as claimed in claim 1, wherein said cable includes an elongate structural component at a central region thereof.

8. The power umbilical cable as claimed in claim 1, wherein said outer protection layer includes at least one layer of armour and at least one layer of polymeric material therearound.

9. The power umbilical cable as claimed in claim 1, wherein said one or more phases are fabricated so that their wires have progressively smaller diameter radially outwardly from their corresponding one or more elements.

10. A phase including a core including a plurality of elongate conductive wires, said core being surrounded by a circumferential insulating sheath, wherein said core includes a central elongate element therein surrounded by said plurality of wires, said central elongate element being operable to flex to reduce a strain experienced in operation by said plurality of elongate conductive wires.

11. The phase as claimed in claim 10, wherein said plurality of elongate conductive wires are fabricated from Copper, and said central elongate element is fabricated from a flexible polymeric material.

12. A method of enhancing strain properties of a power umbilical cable, said method comprising the steps of:
(a) arranging for a power umbilical cable to including one or more axial elongate phases for conducting electrical current, and one or more axial elongate structural components adapted to undergo stress to withstand axial and bending strain applied to the power umbilical cable in operation, said umbilical cable being protected within an outer protection layer; and
(b) including in said one or more elongate phases corresponding one or more current conducting cores, wherein each core comprises a plurality of mutually abutting conductive metal wires, and wherein each current conducting core includes at a central portion therein surrounded by said plurality of conductive metal wires, said central portion including a flexible element operable to enable said wires to move in a radial direction to reduce their strain when said umbilical cable is subject in operation to stress causing said one or more elongate structural components to be axially strained.
